(19) United States
(12) Patent Application Publication
(10) Pub. No.: US 2005/0210770 A1
(43) Pub. Date: Sep. 29, 2005

(54) Pocket door assembly

(76) Inventor: Timothy L. Fackler, Virginia City, NV (US)

Correspondence Address: VIRTUAL LEGAL, P.C.;MICHAEL A. KERR, 3476 EXECUTIVE POINTE WAY, UNIT 16, CARSON CITY, NV, 89706, US

(21) Appl. No.: 10/809,252

(22) Filed: Mar. 25, 2004

(51) Int. Cl. E04B 1/00; B60J 1/16; E05F 11/38

(52) U.S. Cl. 52/105; 52/204.1

(57) ABSTRACT

The pocket door assembly is installed into a framed structure. The pocket door assembly comprises a horizontal header element, a track element, a vertical back support, a horizontal bottom element, a pair of vertical supports, and a means for generating a square corner. The horizontal header element, track element, and horizontal bottom element share a plurality of markings for fitting various standard sized pocket doors. During the manufacturing process the assembler uses these markings as cut-off points. The pocket door assembly is assembled by first fixedly coupling the track element to the horizontal header element. The horizontal header element and the horizontal bottom element are then fixedly coupled to the vertical back support using the means for generating a square corner. For illustrative purposes only, the means for generating a square corner includes a gusset that is shaped as a triangle with cavities for receiving a plurality of screws. The pair of vertical supports are substantially parallel to the vertical back support and define a cavity that receives the pocket door. The pair of vertical supports are configured to be fixedly coupled to the horizontal header element and the horizontal bottom element.

### BACKGROUND

1. Field

The field is related to sliding doors used in residential and commercial structures. More particularly, the field is related to pocket doors.

2. Description of Related Art

Recently, there has been renewed interest in the installation of pocket doors in residential and commercial structures. Pocket doors are doors that do not swing open, rather pocket doors are inserted into a “pocket” within a wall. Thus, when the pocket door is in an open position, the pocket door is disposed with the pocket.

There are a variety of different construction techniques for the installation of pocket doors. Currently, pocket doors are assembled or fabricated in a facility that specializes in the selling of doors and door jams. Typically, the door fabricator sells a newly assembled pocket door with door jams and a door directly to contractors that will be installing the pocket door at the residential or commercial structure. Generally, the door fabricator assembles a wood frame that is adapted to receive the pocket door. The door fabricator then adds the door casing materials, door jam material, and door.

This assembly process is time consuming, and typically results in a wood frame that is not plumb and/or level. A pocket door assembly that is not flush and/or level requires additional installation time because the installer must “shim” the pocket door assembly so that it fits properly. Another deficiency in the current manufacturing techniques for pocket door assemblies is that although they accommodate the 1⅜″ inch pocket doors, they do not easily accommodate wider 1¾″ inch pocket doors. Typically, the channel through which the pocket door travels is limited in its width to 2 inches and the channels bow in or warp out.

### SUMMARY

The pocket door assembly is installed into a framed structure. The pocket door assembly comprises a horizontal header element, a track element, a vertical back support, a horizontal bottom element, a pair of vertical supports, and a means for generating a square corner. The horizontal header element, track element, and horizontal bottom element share a plurality of markings for fitting various standard sized pocket doors. During the manufacturing process the assembler uses these markings as cut-off points. The pocket door assembly is assembled by first fixedly coupling the track element to the horizontal header element. The horizontal header element and the horizontal bottom element are then fixedly coupled to the vertical back support using the means for generating a square corner. For illustrative purposes only, the means for generating a square corner includes a gusset that is shaped as a triangle with cavities for receiving a plurality of screws. The pair of vertical supports are substantially parallel to the vertical back support and define a cavity that receives the pocket door. The pair of vertical supports are configured to be fixedly coupled to the horizontal header element and the horizontal bottom element.

### BRIEF DESCRIPTION OF THE DRAWINGS

Embodiments for the following description are shown in the following drawings:

FIG. 1A is an isometric view of a pocket door assembly.

FIG. 1B is a side view of the pocket door assembly.

FIG. 1C is a front view of the pocket door assembly.

FIG. 1D is a bottom view of the pocket door assembly.

FIG. 1E is an exploded isometric view of one end of the horizontal header element.

FIG. 1F is an exploded front view of the one end of the horizontal header element.

FIG. 2A is an isometric view of the gusset.

FIG. 2B is a side view of the gusset.

FIG. 2C is a top view of the gusset.

FIG. 3A is an isometric view of the horizontal header element.

FIG. 3B is a side view of the horizontal header element.

FIG. 3C is a top view of the horizontal header element.

FIG. 4A is an isometric view of the track element.

FIG. 4B is a side view of the track element.

FIG. 4C is a top view of the track element.

FIG. 5A is an isometric view of the vertical back support.

FIG. 5B is a side view of the vertical back support.

FIG. 5C is a top view of the vertical back support.

FIG. 6A is an isometric view of the horizontal bottom element.

FIG. 6B is a side view of the horizontal bottom element.

FIG. 6C is a top view of the horizontal bottom element.

FIG. 7A is an isometric view of the vertical support.

FIG. 7B is a side view of the vertical support.

FIG. 7C is a top view of the vertical support.

FIG. 8A is an isometric view of the filler that is coupled to the vertical support.

FIG. 8B is a side view of the filler.

FIG. 8C is a top view of the filler.

### DESCRIPTION

In the following detailed description, reference is made to the accompanying drawings, which form a part of this application. The drawings show, by way of illustration, specific embodiments in which the invention may be practiced. It is to be understood that other embodiments may be utilized and structural changes may be made without departing from the scope of the appended claims.

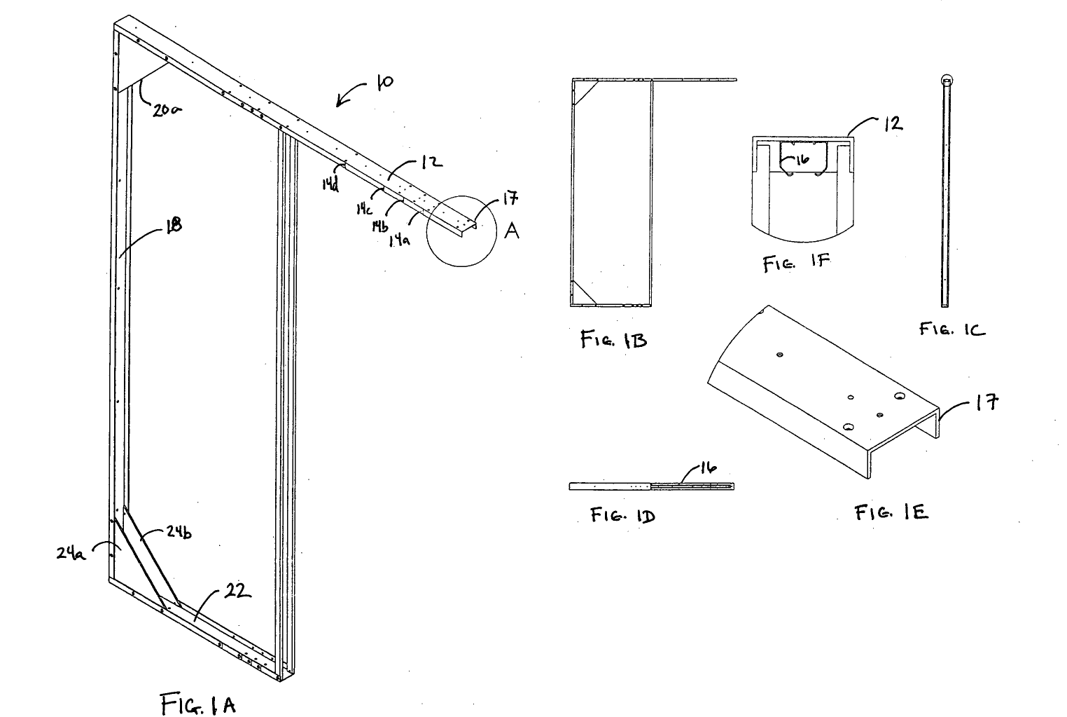

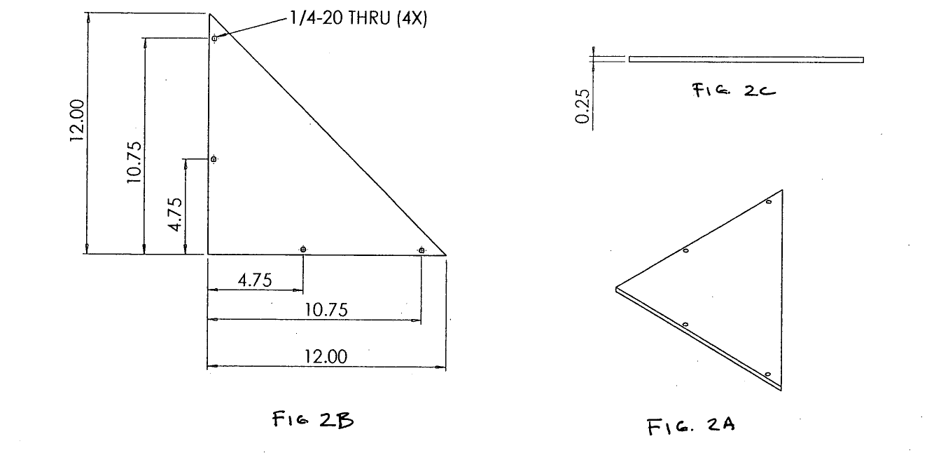

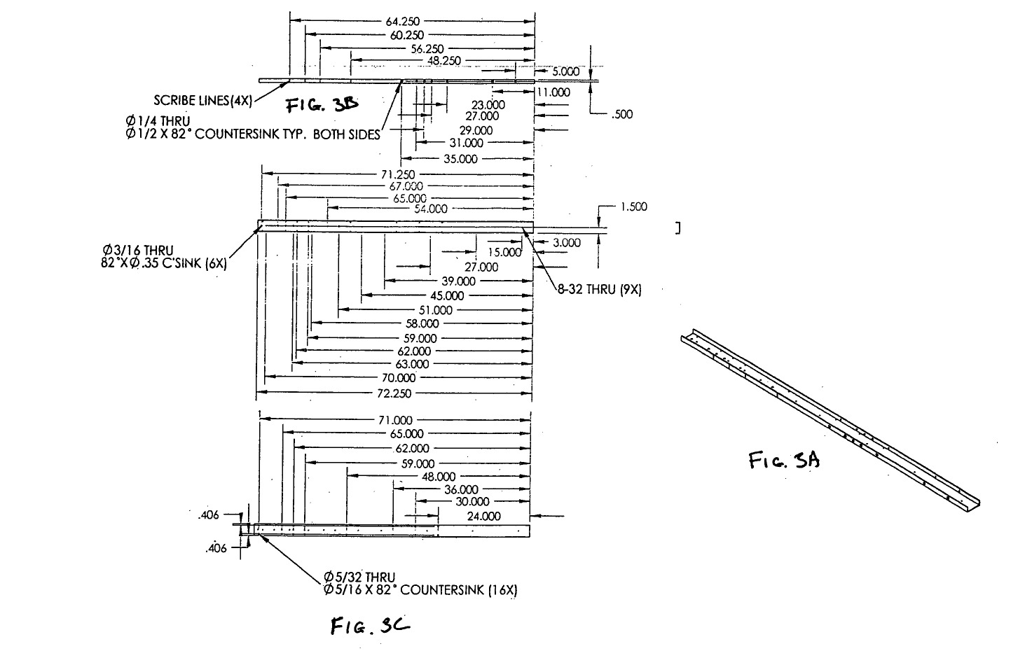

Referring to FIG. 1A there is shown an isometric view of an illustrative pocket door assembly 10 that is received by framed structure. The framed structure may be residential or commercial. FIG. 1B provides a side view of the pocket door assembly 10, and FIG. 1C shows a front view of the pocket door assembly 10. As shown in FIG. 1A, the illustrative pocket door assembly comprises a horizontal header element 12 that has a plurality of markings 14a, 14b, 14c, and 14d for fitting a pocket door (not shown). The horizontal header element 12 is configured to interface with the framed structure.

A track element 16 shown in FIG. 1D and described in further detail below is fixedly coupled to the horizontal header element 12. The track element 16 includes a plurality of markings for fitting the illustrative pocket door. The illustrative pocket door is movably coupled to the track element 16 by an illustrative plurality of wheels that fixedly coupled to the illustrative pocket door. The track element 16 is also shown in FIG. 1F which is an exploded front view of the distal end 17 of the horizontal header element 17. The track element 16 is shorter in length than the horizontal header element 12, which results in the track element 16 not being in the exploded isometric view of the distal end 17 of the horizontal header element shown in FIG. 1E.

Referring back to FIG. 1A, the illustrative pocket door assembly 10 also comprises a vertical back support 18 that is configured to interface with the framed structure. For the illustrative example, the vertical back support 18 is fixedly coupled to the horizontal header element with a visible gusset 20a and gusset 20b. The pair of gussets 20a and 20b provide a square corner. In an alternative embodiment, instead of pair of gussets being used to make the corners square a single gusset can be used for each corner.

The pocket door assembly 10 also includes a horizontal bottom element 22 having the same plurality of markings as the horizontal header element 12 and the track element 16. These marking are configured to provide cut-off points for fitting a plurality of standard sized pocket doors.

A second pair of gussets 24a and 24b is fixedly coupled to the horizontal bottom element 22 and the vertical back support 18. The second pair of gussets 24a and 24b generates another square corner. The horizontal header element 12 and said horizontal bottom element 22 are also fixedly coupled to one another by a pair of vertical supports that are substantially parallel to the vertical back support 18.

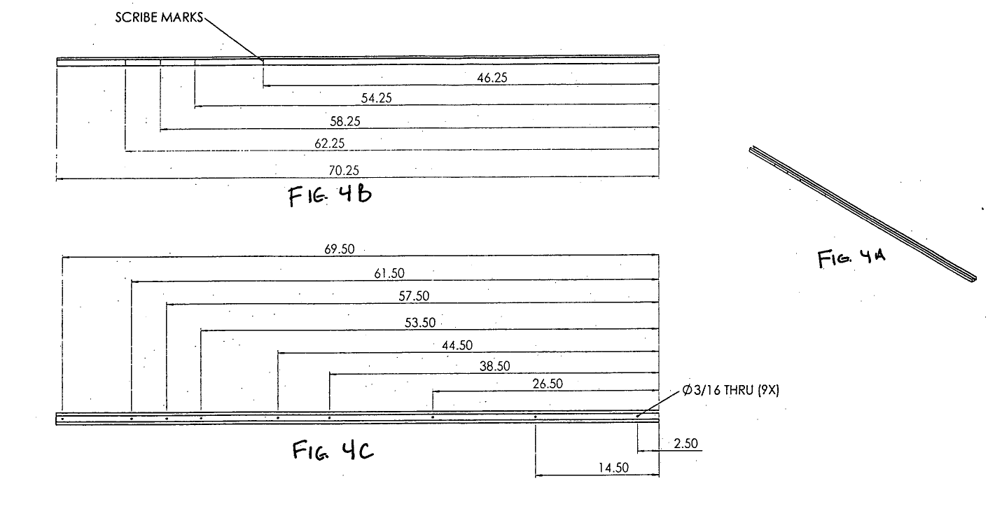

FIG. 2A is an isometric view of one of the illustrative gussets described above. The gusset is one of a plurality of means for generating a square corner when fixedly coupling the horizontal header element 12 to the vertical back element 18. The means for generating a square corner includes a group of connection elements that consist of gussets, plates, rods, stiffeners, angles, brackets, and any other such connection elements. The connection elements are fastened to the vertical supports and horizontal elements using a group of connectors that consist of screws, nails, bolts, welds, rivets or other fastening elements. FIG. 2B is a side view of the gusset showing the locations for drilling holes in the illustrative connection element. FIG. 2C is a top view of the gusset.

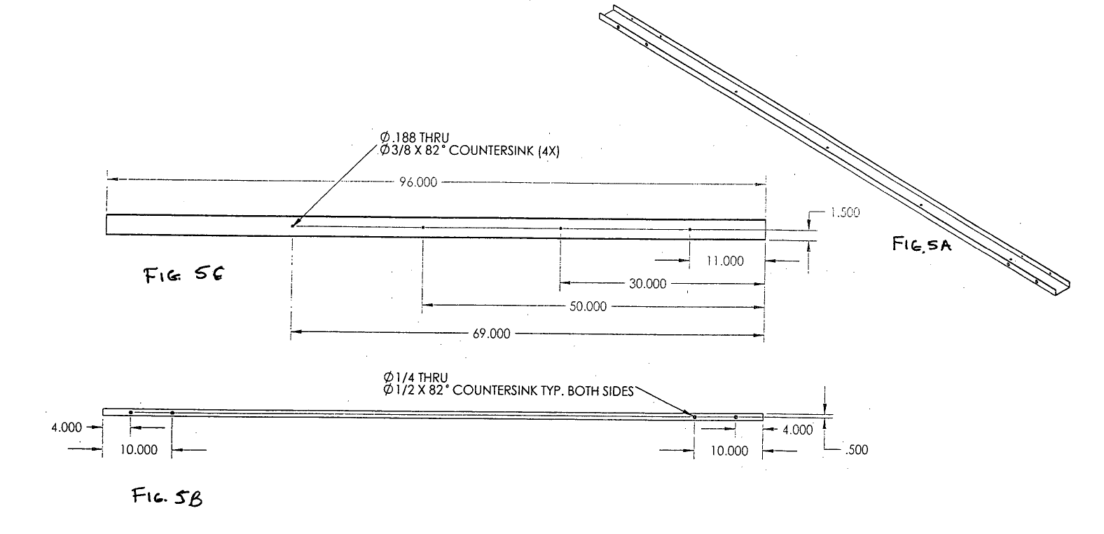

Referring to FIG. 3A there is shown an isometric view of the illustrative horizontal header element with scribe marks at various intervals that 3′0″ door, a 2′8″ door, a 2′6″ door, a 2′4″ door, and a 2′0″ door. FIG. 3B is a side view of the horizontal header element and FIG. 3C is a top view of the horizontal header element.

Referring to FIG. 4A there is shown an isometric view of the illustrative track element that also shows markings or scribe marks at the same intervals as shown for the illustrative horizontal header element. FIG. 4B is a side view of the track element, and FIG. 4C is a top view of the track element.

Referring to FIG. 5A there is an isometric view of the vertical back support 18. The vertical back support is configured to be fixedly coupled to a roughed out opening in the framed structure. FIG. 5B is a side view of the vertical back support and FIG. 5C is a top view of the vertical back support.

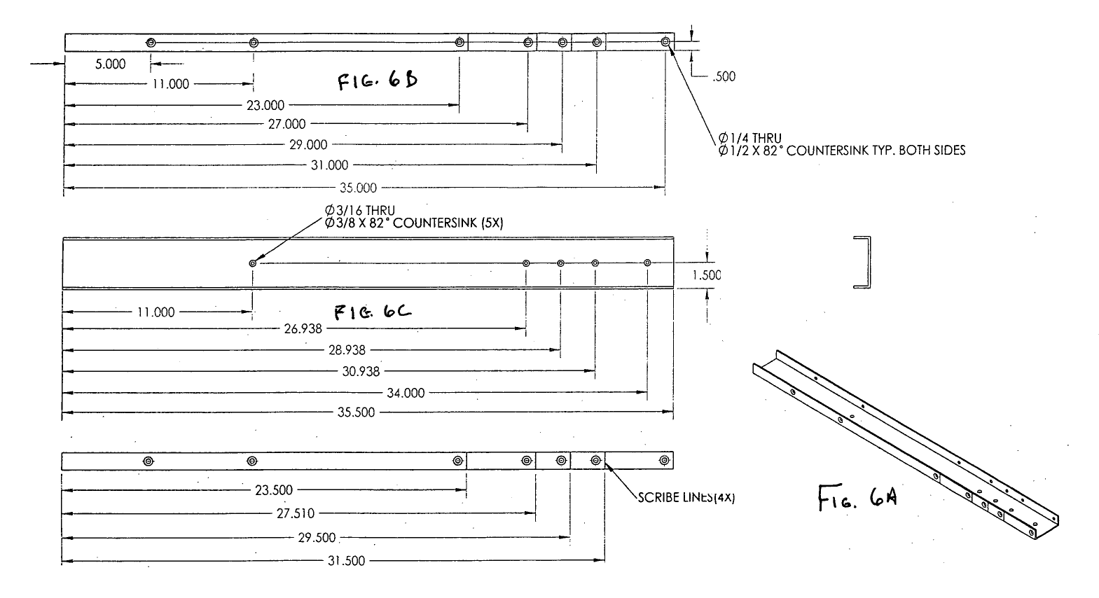

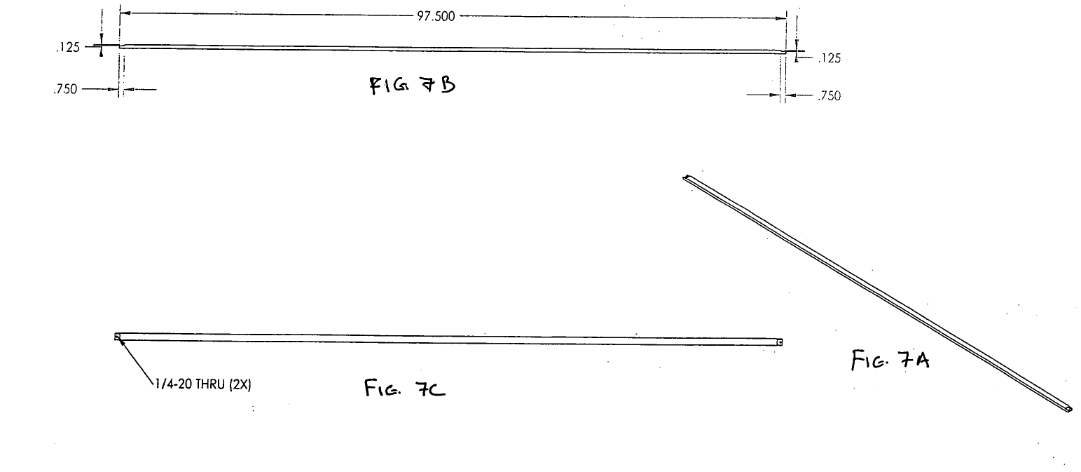

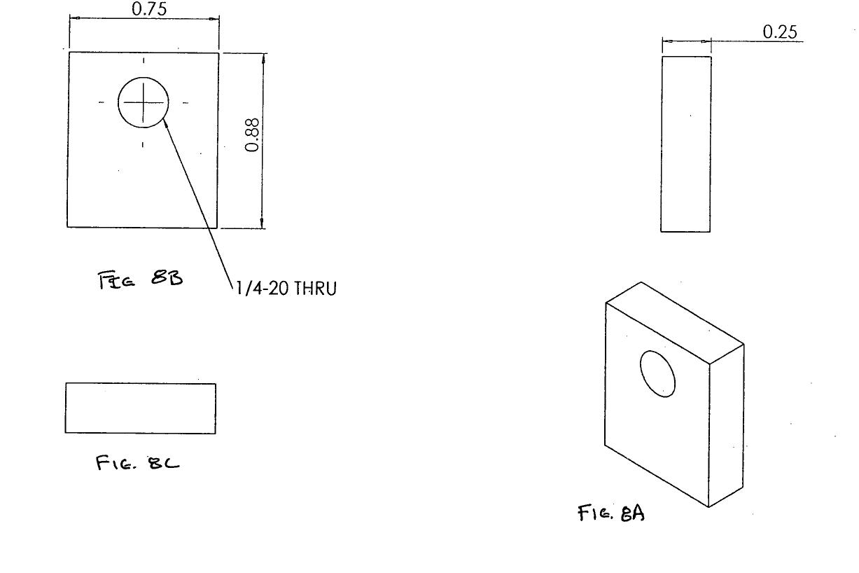

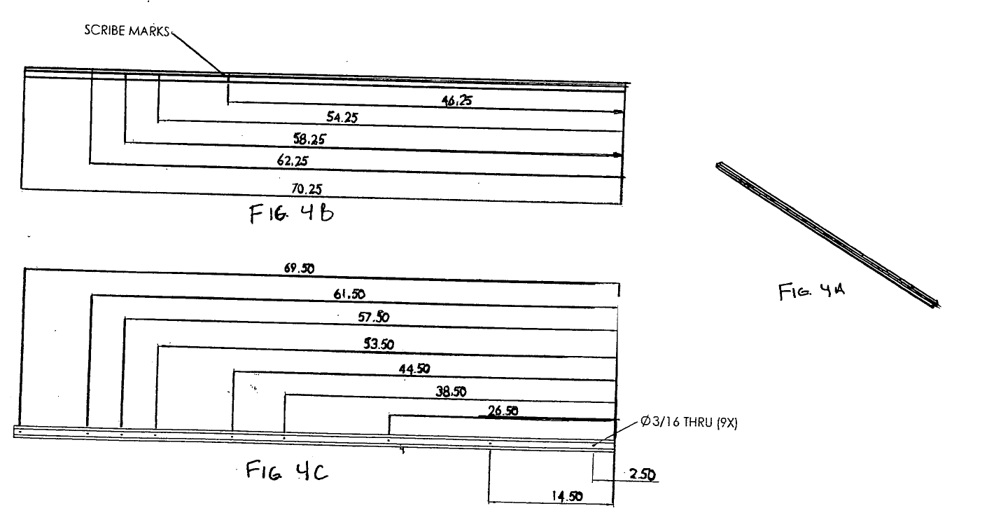

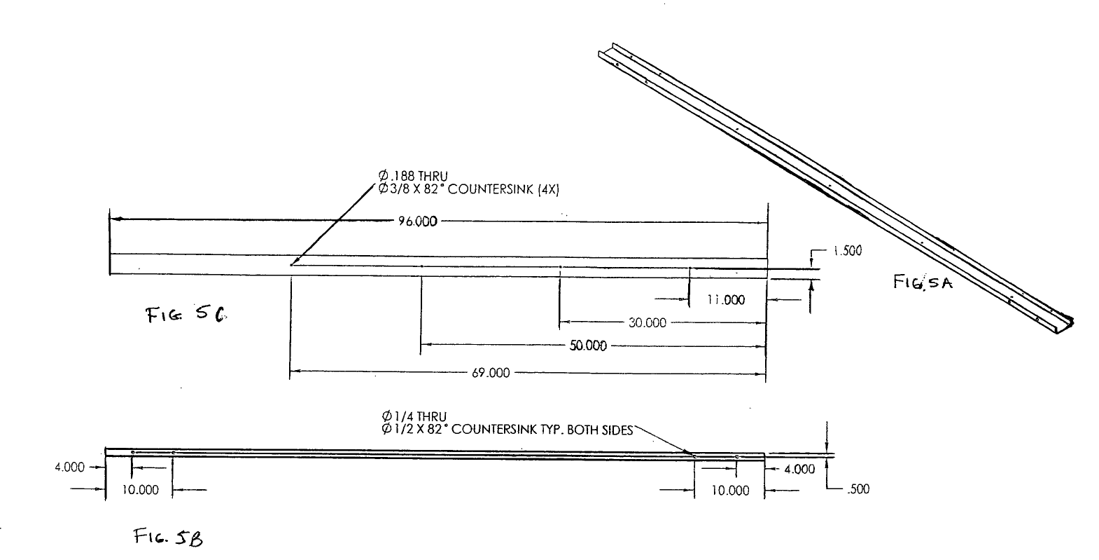

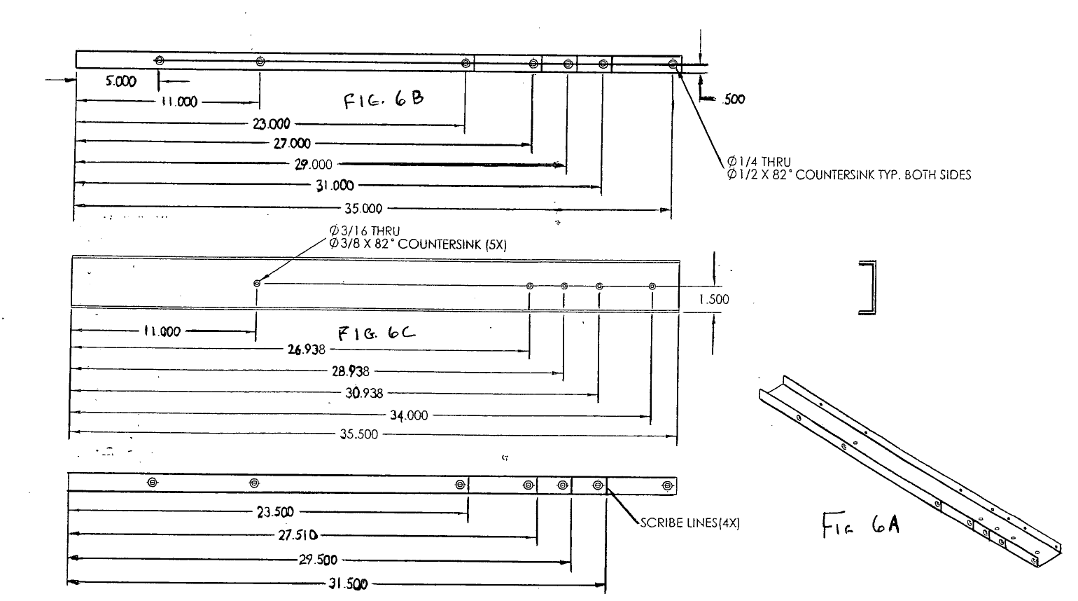

Referring to FIG. 6A there is shown an isometric view of the horizontal bottom element with markings that identify cut-off points for standard sized pocket doors. FIG. 6B is a side view of the horizontal bottom element and FIG. 6C is a top view of the horizontal bottom element.

Referring to FIG. 7A there is shown an isometric view of the vertical support which is fixedly coupled to the horizontal header element and the horizontal bottom element. In FIG. 1A there are a pair of vertical supports that define a cavity which is adapted to receive the illustrative pocket door. FIG. 7B is a side view of the vertical support and FIG. 7C is a top view of the vertical support.

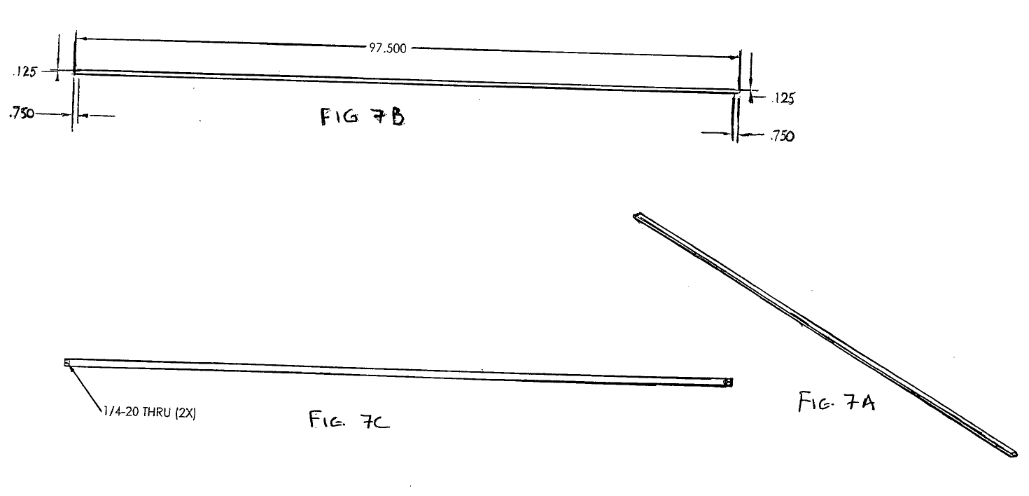

FIG. 8A is an isometric view of the filler that is coupled to the vertical support. The filler is fixedly coupled to the vertical support and permits the vertical support to be fixedly coupled to the horizontal elements using a fastener. The illustrative fastener is a screw. FIG. 8B is a side view of the filler and FIG. 8C is a top view of the filler.

By way of example and not of limitations, the components of the pocket door assembly are composed of aluminum. During the manufacturing of the pocket door assembly, the elements of the pocket door assembly are machined to tolerances that exceed 1/1000 of an inch. Tolerances as high as 1/100,000 of an inch can be achieved. By manufacturing the pocket door assembly at such high tolerances, the pocket door assembly can be assembled so that the horizontal elements are level and the vertical supports are plumb. The benefit of machining to such high tolerances is that the manufactured door is square so that installation process is simplified.

The method for manufacturing the pocket door assembly that is installed in a framed structure comprises assembling the components described above by first determining the dimension for the pocket door which is going to be installed. The pocket door dimension is used to determine which of said plurality of markings is a cut-off point for the horizontal header element, the track element, and the horizontal bottom element. The person assembling the pocket door assembly then proceeds to cut the horizontal header element, the track element, and the horizontal bottom element using an illustrative rotary saw with a metal cut-off blade. Typically, the desired cut is a square cut. The person assembling the pocket door assembly then proceeds to fixedly coupling the track element to the horizontal header element. The vertical back support and the pair of vertical supports are then fixedly coupled to the horizontal header element and the horizontal bottom element using a group of connectors and connecting elements. By way of example and not of limitation a plurality of gussets are used as the connection elements and the connectors are steel screws.

Prior to installation the pocket door assembly is “fitted” with a door frame (not shown) and one or more plywood sheets (not shown). During the installation process, the pocket door assembly 10 is fit with a door frame (not shown) and a plurality of sheets of plywood (not shown). The pocket door assembly 10 configured to be installed to fit a 2×4 wall or a 2×6 wall.

Thus, although the description above contain many limitations in the specification, these limitations should not be construed as limiting the scope of the invention but as merely providing illustrations of some of the presently preferred embodiments of this invention. Thus, the scope of the invention should be determined by the appended claims and their legal equivalents rather than by the examples given.

1. A device for manufacturing a pocket door assembly, comprising:
a horizontal header element having a plurality of markings for fitting a pocket door;
a track element having said plurality of markings for fitting said pocket door, said track element configured to be fixedly coupled to said horizontal header;
a vertical back support;
a first gusset that is fixedly coupled to said horizontal header element and said vertical back support, said first gusset configured to generate a square corner;
a horizontal bottom element having said plurality of markings for fitting said pocket door;
a second gusset that is fixedly coupled to said horizontal bottom element and said vertical back support, said second gusset configured to generate another square corner; and
a pair of vertical supports that are substantially parallel to said vertical back support, said pair of vertical supports configured to be fixedly coupled to said horizontal header element and said horizontal bottom element.

2. The device of claim 1 wherein said track element is configured to receive a plurality of wheels that are fixedly coupled to a pocket door.

3. The device of claim 1 wherein said plurality of markings are configured to fit a plurality of standard sized pocket doors.

4. The device of claim 1 wherein said first gusset and said second gusset further comprises a pair of first gussets and a pair of second gussets.

5. The pocket door assembly of claim 1 that is fit with a door frame and a plurality of sheets of plywood.

6. The pocket door assembly of claim 5 configured to be installed to fit a 2×4 wall.

7. The pocket door assembly of claim 5 configured to be installed to fit a 2×6 wall.

8. An apparatus for manufacturing a pocket door assembly that is received by a framed structure, said apparatus comprising:
a horizontal header element having a plurality of markings for fitting a pocket door, said horizontal header element configured to interface with said framed structure;
a track element having said plurality of markings for fitting said pocket door, said track element configured to be fixedly coupled to said horizontal header and configured to be slidably coupled to said pocket door;
a vertical back support configured to interface with said framed structure;
a first means for generating a square corner by fixedly coupling said horizontal header element to said vertical back support;
a horizontal bottom element having said plurality of markings for fitting said pocket door;
a second means for generating a square corner by fixedly coupling said horizontal bottom element to said vertical back support; and
a pair of vertical supports that are substantially parallel to said vertical back support, said pair of vertical supports configured to be fixedly coupled to said horizontal header element and said horizontal bottom element.

9. The apparatus of claim 8 wherein said first means and second means for generating a square corner comprises a group of connection elements that consist of gussets, plates, rods, stiffeners, angles, brackets, and any other connection element.

10. The apparatus of claim 9 wherein said first means and second means for generating a square corner comprises a group of connectors that consist of screws, nails, bolts, welds, rivets or other fastening elements.

11. The apparatus of claim 8 wherein said plurality of markings are configured to fit a plurality of standard sized pocket doors.

12. The apparatus of claim 8 that is fit with a door frame and a plurality of sheets of plywood for installation in said framed structure.

13. The apparatus of claim 12 configured to be installed to fit a 2×4 wall.

14. The apparatus of claim 12 configured to be installed to fit a 2×6 wall.

15. A method for manufacturing a pocket door assembly that is installed in a framed structure, comprising:
providing a horizontal header element, a track element, and a horizontal bottom element, each of said elements having a plurality of markings for fitting a pocket door with different dimensions;
determining a dimension for said pocket door;
using said dimension to determine which of said plurality of markings is a cut-off point for said horizontal header element, said track element, and said horizontal bottom element;
cutting at said cut-off point;
fixedly coupling said track element to said horizontal header element
providing a vertical back support and a pair of vertical supports;
fixedly coupling said vertical back support, said pair of vertical supports, said horizontal header element with said track element, and said horizontal bottom element so that each of said horizontal elements are substantially orthogonal to each of said vertical supports.

16. The method of claim 15 further comprising fitting said pocket door assembly with a door frame and one or more sheets of plywood.

17. The method of claim 16 further comprising installing said pocket door assembly into a 2×4 wall.

18. The method of claim 16 further comprising installing said pocket door assembly into a 2×6 wall.

19. The method of claim 15 wherein said fixedly coupling said vertical back support, said pair of vertical supports, said horizontal header element with said track element, and said horizontal bottom element so that each of said horizontal elements are substantially orthogonal to each of said vertical supports, further comprises using a group of connectors and a group of connecting elements for manufacturing said pocket door assembly.

20. The method of claim 19 wherein said group of connecting elements comprises a plurality of gussets said group of connectors comprises a plurality of screws.
